(19) United States
(12) Patent Application Publication
(10) Pub. No.: US 2019/0318837 A1
(43) Pub. Date: Oct. 17, 2019

(54) Method For Characterising One Or More Faults In A System

(71) Applicants: Electricite de France, Paris (FR); Metroscope, Levallois-Perret (FR)

(72) Inventors: Aurélien Schwartz, Thise (FR); David Pineau, Vertou (FR)

(73) Assignees: Electricite de France, Paris (FR); Metroscope, Levallois-Perret (FR)

(21) Appl. No.: 16/471,857

(22) PCT Filed: Dec. 14, 2017
(86) PCT No.: PCT/FR2017/053577

§ 371 Date: Jun. 20, 2019

(30) Foreign Application Priority Data
Dec. 22, 2016 (FR) 1663261

(51) Int. Cl. G21D 3/00; G06F 17/50; G06F 17/16; G21D 3/06

(52) U.S. Cl. CPC G21D 3/001; G21D 3/06; G06F 17/16; G06F 17/5009

(57) ABSTRACT

The invention relates to a method for characterising one or more faults in a system grouping together a plurality of internal physical quantities and delimited by a plurality of boundary physical quantities, the system being modelled by a healthy model establishing relationships linking said internal physical quantities with one another and with the boundary physical quantities in the absence of a fault, a fault being defined as an alteration in the relationships linking said internal physical quantities with one another and with the boundary physical quantities with respect to the healthy model, wherein a fault is characterised by counting a number of iterations having involved said fault in a series of iterations involving a fault matrix.

### GENERAL TECHNICAL FIELD AND CONTEXT OF THE INVENTION

The present invention relates to the field of the control and the monitoring of a physical system. More specifically, the invention pertains to the characterisation of one or more faults of a complex industrial system.

Any system may have faults, that is to say undesired modifications of some of its physical quantities representative of operation, which may be due to numerous factors (ageing of a component, malfunctioning of a component, etc.). These faults can take diverse forms, depending on their nature and the component concerned, and be reflected differently in the physical quantities representative of the operation of the system. Nevertheless, a fault in a system compromises the operation of the system, which then has a degraded operation with respect to the operation of the system in the absence of a fault, which is called the healthy system.

The performance of an industrial system and its maintaining over time constitute a major challenge for all industry. The limitation of the number and the duration of stoppages for maintenance, as well as the optimisation of efficiency are important sources of operating profits. The optimisation of the efficiency of an industrial system involves in particular the detection, the localisation and the quantification, with the best precision possible, of the impact of different degradations. This information makes it possible to trigger suitable maintenance actions and may, with time, be used to define an efficient preventive maintenance strategy.

Every important industrial system is equipped with sensors that have for mission to monitor the values taken by the physical quantities representative of the operation of the system. A problem is detected when a measurement coming from a sensor differs from a normally accepted value, which would indicate a degradation of the performance of a component or internal process of the system. However, such detection does not provide information on the nature of the fault in the system, but only makes it possible to detect a symptom thereof. Furthermore, the system may have a fault which, although affecting one or more measured values, does not bring about sufficient modification of these measured values to be detected, especially since the values of the physical quantities vary as a function of management and physical quantities external to the system.

It then comes down to an operator to analyse the measurements to try to characterise the fault in the system, by implementing different tools such as decision trees, digital simulation models, or instead tools based on statistical learning methods, and above all based on his personal experience of the behaviour of the system, or the experience recorded by others in these tools.

The detection and the characterisation of a fault is thus based on the manipulation of large amounts of information and of various types (measurements, professional knowledge, uncertainties, modelling) and on complex interactions. The carrying out of such diagnoses requires, for non-trivial cases, systematically resorting to expert services, and suffers from not having any method able to integrate the problems encountered in all of their complexity. Moreover, the time required to conduct these operations delays as much the implementation of actions required to correct the fault.

Monitoring methods have been developed using electronic monitoring (e-monitoring) learning algorithms. These learning algorithms seek to characterise the behaviour of the system using a history of monitoring data of the system, in a fault-free mode and in the presence of known faults. The learning algorithm uses the values measured by the sensors, and compares them with the data of the learning data base.

For example, the document EP 1 677 172 A2 describes a method for monitoring and detecting faults in an aircraft engine, wherein residuals are calculated, corresponding to the differences between detected signals and estimations based on an extended Kalman filter. Then, from a Bayesian hypothesis test, the probability of belonging to one of the known types of fault is determined starting from the residuals, the level of correlation finally making it possible to obtain the severity of the detected error.

However, a learning based method is difficult to apply to complex systems because it is incapable of exploring empirically all the nominal operating conditions of the system, especially since these diagnosis methods are often limited in the number of sensors that they can have embedded. In addition, it is almost impossible to guarantee that the supervised learning period of such a method indeed corresponds to the nominal operation of the installation. Lessons learned on the use of these methods bear witness to the significant generation of false alarms linked to learning limits, that is to say by errors in characterisation of the domains of nominal operation and faults.

Yet, the characterisation of faults intervening in a system is especially important since it conditions the actions to undertake to correct these faults. A lack of certainty on the characterisation of the fault may prevent the accomplishment of the appropriate actions which could make it possible to remedy the fault, and thus to regain production losses or to prevent an aggravation of the state of the affected component.

Moreover, the learning algorithm requires regular and complete re-learnings of the behaviour of the system to enrich the knowledge thereof in particular operating conditions or to compensate for metrological problems (re-calibrations of sensors). The maintenance and the updating of such an algorithm thus proves to be particularly onerous.

In addition, the learning algorithm can only detect and identify degradations of operation already encountered, identified by an operator, and implemented in the algorithm.

Moreover, such methods based on a learning algorithm require that the system is already physically installed and necessitate having available a measurement history data base. The direct consequence is that these diagnostic tools cannot be implemented as of the reception of a new industrial system.

### DESCRIPTION OF THE INVENTION

The invention hereafter describes a method for characterising one or more faults in a system, which exploits knowledge of the nominal behaviour of the system whatever the boundary conditions thereof, and without dimensional limit, and which makes it possible to identify and to characterise the faults occurring in a system in a detailed manner.

The invention proposes to this end a method for characterising one or more faults in a system grouping together a plurality of internal physical quantities and delimited by a plurality of boundary physical quantities, the system being modelled by a healthy model establishing relationships linking said internal physical quantities with one another and with the boundary physical quantities in the absence of a fault, a fault being defined as an alteration in the relationships linking said internal physical quantities with one another and with the boundary physical quantities with respect to the healthy model,

said system being provided with a plurality of sensors measuring values of the internal physical quantities and the external physical quantities,
the method comprising the implementation of the steps of:
construction of a vector of the measured measurements of a set of internal physical quantities by reading the values of internal physical quantities measured by the sensors,
determination of a vector of actual symptoms by the difference between the vector of measured measurements and a vector of simulated measurements, said vector of simulated measurements grouping together the values of internal physical quantities obtained by simulation of the healthy model from the boundary physical quantities,
and, for a determined number of iterations:
   determination of a proposed vector of faults from a current vector of faults by a pseudo-random sampling using a probability law on each of the fault values of the current vector of faults, a vector of faults grouping together values representative of one or more faults;
   determination of the probability of acceptance of the proposed vector of faults using the vector of actual symptoms, a fault matrix, the current vector of faults, the probabilistic distribution of the vector of actual symptoms given the current vector of faults, the proposed vector of faults, the probabilistic distribution of the vector of actual symptoms given the proposed vector of faults, and an a priori probability distribution of occurrences of the values of the fault vector, said fault matrix grouping together the consequences of each fault on the internal physical quantities;
   replacement or not of the current vector of faults by the proposed vector of faults as a function of the probability of acceptance of the proposed vector of faults,
characterisation of a fault by counting the number of iterations having involved said fault.

The invention is advantageously completed by the following different characteristics taken alone or according to their different possible combinations:
the determination of the probability of acceptance of the proposed vector of faults uses a proposed vector of symptoms and a current vector of symptoms, the current vector of symptoms being determined from the current vector of faults using the fault matrix, and the proposed vector of symptoms being determined from the proposed vector of faults using the fault matrix;
each column of the fault matrix corresponds to a signature vector of at least one fault representative of the impact of said fault on the internal physical quantities measured by the sensors, and the number of lines of the matrix is determined by the number of measured internal physical quantities taken into account and the number of columns of the matrix is determined by the number of faults taken into account;
the method includes a prior step of determination of the fault matrix, in which is determined for each fault:
   a first vector of simulated measurements by simulation of the healthy model from the boundary physical quantities;
   a second vector of simulated measurements by simulation of the healthy model by altering the relationships of the healthy model as a function of the fault with the same boundary physical quantities;
   the signature vector of the fault corresponding to the difference between the second vector and the first vector;
a set of faults affecting the system are known beforehand and entered into a vector of known faults, and during iterations, the current vector of faults is completed by the vector of known faults;
the current vector of symptoms is determined from the fault matrix, the current vector of faults and the vector of known faults, and the proposed vector of symptoms is determined from the fault matrix, the proposed vector of faults and the vector of known faults;
the characterisation of a fault includes the determination of the probability of the presence of the fault in the system and/or the determination of a value of this fault;
the probability of acceptance of the proposed vector of faults is determined by comparing the density of the joint law at the point of the proposed vector of faults with the density of the joint law at the point of the current vector of faults, the densities of the joint law at the aforementioned points being determined by the vector of actual observed symptoms, the fault matrix, the proposed vector of faults, the current vector of faults, the probabilistic distribution of the symptoms vector given the current vector of faults, the probabilistic distribution of the symptoms vector given the proposed vector of faults, and the a priori probability distribution of occurrences of the values of the fault vector.

The invention also relates to a computer programme product comprising programme code instructions for the execution of the steps of the method according to the invention, when said programme is executed on a computer. Preferably, this computer programme product takes the form of a support readable by computer on which are stored said programme code instructions.

### PRESENTATION OF THE FIGURES

Other characteristics, aims and advantages of the invention will become clear from the description that follows, which is purely illustrative and non-limiting, and which should be read with regard to the appended figures in which:

FIG. 1 is a schematic diagram illustrating the main steps of the characterisation method;

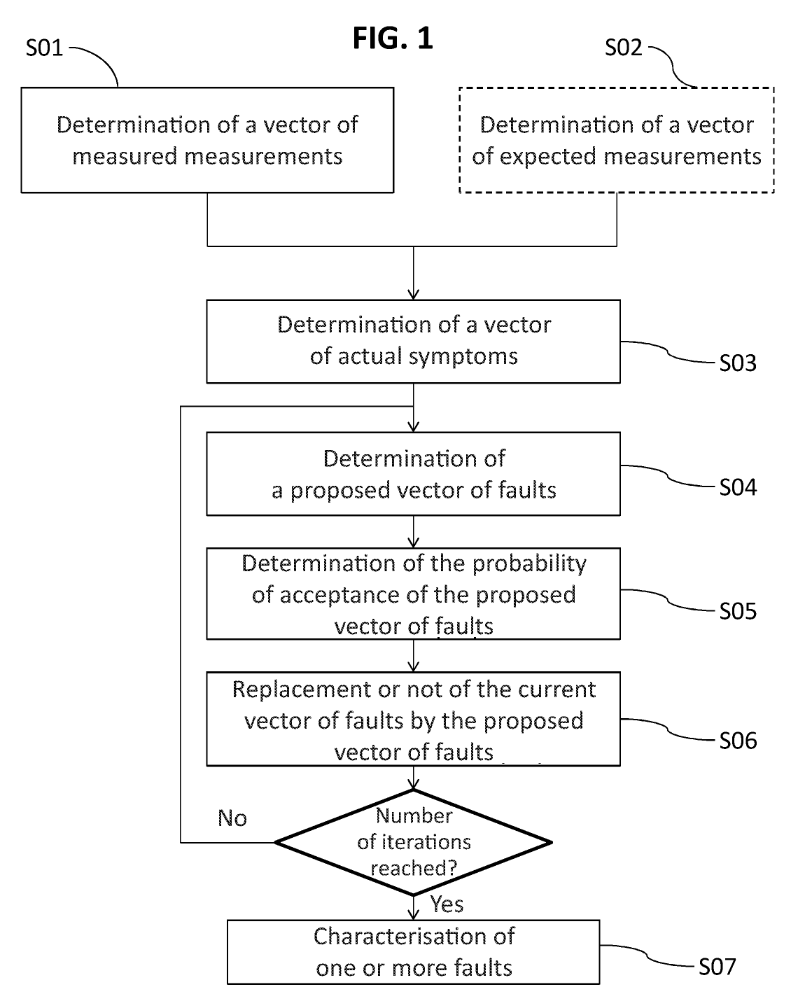

FIG. 2 is an illustrative diagram of a Bayesian tree.

### DETAILED DESCRIPTION

A system groups together a plurality of internal physical quantities and is delimited by a plurality of boundary physical quantities. The evolution of the internal physical quantities depends on the operation of the system, whereas the evolution of the boundary physical quantities does not depend on the operation of the considered system. Thus, among the boundary physical quantities are found for example the external temperature or an operational set point for the system, imposed by a user external to the system. The boundary physical quantities are thus external to the considered system, and are thus independent of faults therein.

The system is instrumented, that is to say that it is provided with a plurality of sensors measuring values of internal physical quantities and external physical quantities. Preferably, the system includes at least ten sensors. Indeed, the invention is robust and particularly interesting in large dimensions. From ten or so sensors, it differs from methods of the prior art working on the basis of a learning incapable of efficiently characterising poorly instrumented complex problems.

For illustration and in a non-limiting manner, the invention will be described hereafter in the case where the system of which the faults are to be characterised is a part of a nuclear power plant. The invention may be applied to other types of systems or installations, and in particular to any electricity production power plant (carbon or gas power plant for example).

The considered system is constituted by the secondary circuit of a nuclear reactor. The secondary circuit is a closed circuit for circulating a heat transfer fluid receiving at the level of a steam generator heat coming from the primary circuit and supplying mechanical work to a turbo-generator group producing electricity.

Such a secondary circuit of a nuclear power plant includes several hundred sensors. However, it is not necessary to exploit all the measurements, and the invention may be implemented by exploiting fewer sensors, by selecting the most relevant to take into account a fault. As an example, it is possible to implement the method for a secondary circuit of a nuclear power plant by exploiting around 80 different sensors, which thus produce 80 measurements of 80 physical quantities.

In this example, the boundary physical quantities may for example be selected from the flow rate and the temperature of the fluid of the primary circuit entering into the steam generator, the temperature and the flow rate of the cold source of a condenser, the electrical power drawn by the network, the flow rate of purges, etc. The internal physical quantities are for example the temperatures, pressures or flow rates of the heat transfer fluid at different spots of the secondary circuit, etc.

The system is modelled by a healthy model establishing relationships linking internal physical quantities with one another and with boundary physical quantities in the absence of a fault. Each of the sensors of the system is identified in the healthy model. The modelling of the system is performed from the components of the system and physical equations known to those skilled in the art. In the example of the nuclear power plant, the healthy model thereby designates the complete modelling of the secondary circuit in established operation and at full power. The model is based on boundary conditions of the secondary circuit and, in simulation, re-computes the internal physical quantities, that it is possible to qualify as thermohydraulic for the secondary circuit, for each measurement point on the circuit. During a simulation, the model computes the expected thermohydraulic state of the system from the boundary conditions. It computes in particular the expected values for each internal physical quantity measured by a sensor.

Creation of the Fault Matrix

The method includes a prior step of creation of a fault matrix M faults for the system. A fault is a physical breakdown capable of impacting the thermohydraulic operation of the system. A fault matrix groups together all of the signatures of each fault, and thus the physical breakdowns capable of impacting the thermohydraulic operation of the system. For the secondary circuit, it may for example involve the loss of leak tightness of a valve, the rupture of a heater unit tube, a mechanical deterioration of the turbine blades, etc.

A fault is thereby defined as an alteration in the relationships linking the internal physical quantities with one another and with the boundary physical quantities with respect to the healthy model. The creation of the fault matrix is based on the modelling of the system under degraded conditions. Each fault taken into account by the method is specifically simulated, and makes it possible to create a vector of simulated measurements symptomatic of the fault, which is used to construct the matrix.

The fault matrix defines the consequence of a plurality of possible faults listed for the system on the internal physical quantities. The fault matrix capitalises, for each fault embedded in the diagnosis, its signature on all of the measurements available. Hence the fault matrix performs a matrix approximation of the degraded model for computing time considerations. The fault matrix takes the form of a mathematical matrix (i.e. an organised set of data according to several dimensions).

The number of lines of the matrix is determined by the list of internal physical quantities of the system measured by sensors available on the system and taken into account in the method. The number of faults capable of affecting the system, known at least partially by the expertise of those skilled in the art, makes it possible to determine the number of columns of the matrix. It is to be noted that it is possible to anticipate faults not yet encountered by those skilled in the art, but listed as possible occurrences, for example by listing all the possible breakdowns of each component of the system (leak, rupture, fouling, clogging, etc.). This makes it possible to prepare the diagnoses of industrial systems as of their design phase.

This matrix aspect makes the method easily evolutive, since the taking into account of an internal physical quantity (for example by the addition of a sensor measuring an internal physical quantity) results in the addition of a new line to the fault matrix. Similarly, the identification of a new fault results in the addition of a new column.

Filling in the Fault Matrix by Modelling

Each column of the fault matrix constitutes the signature of a degradation on all of the sensors, that is to say the impact that this fault has on each measured internal physical quantity taken into account, each line corresponding to a measured internal physical quantity.

The signature of each fault is thus searched for, of which the impacts on each sensor constitute the components of the fault matrix. It is to be noted that the components of the matrix are not necessarily constant coefficients.

The components of the fault matrix are determined by simulation of a modelling of the system under degraded conditions. From the healthy model, each fault is implemented in the healthy model by modifying the internal parameters of the healthy model, that is to say by modifying the translation in the model of the relationships linking the said internal physical quantities with one another and with the boundary physical quantities, and if necessary by adding suitable equations to take into account the degradation corresponding to the fault. For example, if the conveyance of fluid in a healthy pipe conserves the flow rate, there is thus a relationship of conservation of the flow rate in the pipe. On the other hand, a leak in the pipe will result in a loss of the leakage flow rate in the pipe. It is thus advisable to represent this fault by a modification of the equation linking the input and output flow rates of the pipe.

Di notes the fault, for example a leak, and di the value of this fault, for example the flow rate of the leak. It is to be noted that a same fault can take several values characterising its amplitude, such as for example several flow rates for a same leak. For each fault (and potentially for each fault value) a vector of simulated measurements corresponding to the faulty operation of the system is determined, which is compared to a vector of simulated measurements corresponding to the healthy operation of the system.

On the one hand, a vector of simulated values V_{measurements,Di=0}^{stimulated} of all of the internal physical quantities is available by prior simulation of the healthy model from the boundary physical quantities. A same vector of simulated measurements V_{measurements,Di=0}^{stimulated} of the healthy model may be used to characterise all of the faults. Indeed, since the healthy model of the system is not modified (except for modification of the system, for example in the event of replacement of a component of the system by another with other characteristics), the values resulting from a simulation will be the same. It is thus not necessary to perform the simulation of the healthy model again to characterise each fault.

On the other hand, from the model degraded by the fault, a vector of simulated measurements V_{measurements,Di=di}^{stimulated} of all of the internal physical quantities is then obtained by simulation of the degraded model from the same boundary physical quantities.

The response of the system to the fault is approximated as being a response of the healthy model to which is added the signature of the fault Di at its value di:

V_{measurements,Di=di}^{stimulated}≅V_{measurements,Di=0}^{stimulated}+ [symbol] _{signature Di}(di)

with [symbol] _{signature Di}: di→ [symbol] _{signature Di}(di) the analytical approximation function of the signature of the fault D, defined for all the values di of Di.

To simplify, it is possible to use a linear approximation to characterise the behaviour of the faulty system, which results in the use of a signature vector V_{signature Di} with constant coefficients:

V_{measurements,Di=di}^{stimulated}≅V_{measurements,Di=0}^{stimulated}+di×V_{signature Di}

Since the vectors of simulated values V_{measurements,Di=0}^{stimulated} and V_{measurements,Di=di}^{stimulated} are known by simulation of the healthy model and of the degraded model, it is thereby possible to determine the signature of the fault, which can take according to the case the form of a signature vector V_{signature Di} or a signature function [symbol] _{signature Di}: di→ [symbol] _{signature Di}(di) making it possible to determine a signature vector. By extension, it is to be noted that the function [symbol] _{signature Di} may also be defined on a space with several dimensions, the elements of this space being vectors representative of an accumulation of faults. This is interesting if the coexistence of several faults generates mutual impacts on their respective signatures. In the description that follows, a signature vector V_{signature Di} with constant coefficients will be used for simplification.

In the case where the simulation of a faulty behaviour of the model is not possible (ignorance of the degradation phenomenon, etc.), or to consolidate a signature derived from the digital fault model, it may be envisaged to draw on the archive of measurements of the system during a past fault diagnosed retrospectively, to reveal the signature thereof. To do so, it suffices to compare the archived measurements with the simulation results of the healthy model in the conditions of occurrence of the fault.

The fault matrix may then be constructed since each column of this fault matrix corresponds to a signature vector of a fault. As indicated above, the modification of the operation of the healthy system in the presence of a fault is thereby modelled thanks to the fault matrix which defines the expected consequence of each listed fault on the internal physical quantities.

Acquisition of Measurements of the System

As indicated above, the system is provided with a plurality of sensors measuring values of internal physical quantities and external physical quantities required for the operation of the healthy model. These sensors are used to read the measurements of a set of internal physical quantities.

Preferably, the method is applied to a stabilised system in a stationary or periodic state, which may be described by quantities independent of time (e.g. frequency, dephasing, amplitude). Consequently, before acquiring the measurements enabling the characterisation of the potential fault, the operation of the system is stabilised in order to guard against possible transitory effects. It involves not modifying the operating parameters of the system. In the case of a secondary circuit of a nuclear power plant, it involves keeping fixed the level of electrical production and not acting on the valves of the circuit. In this case and as an indication, 5 to 10 minutes of stabilisation making it possible to have available measurements sufficiently stable are followed by 20 minutes of acquisition of measurements by the sensors.

During the stabilised regime, the measurements by the sensors of a set of internal physical quantities are read. A vector of the measured measurements Vₘₑₐₛᵤᵣₑₘₑₙₜₛ^{measured} is thereby constructed (step S01) from these readings. Preferably, for each sensor, a plurality of measurements are read, and their average is used. For example, measurements may be read periodically, for example every 2 seconds, for each sensor. The average value of these measurements then constitutes the value of the measurement for this sensor.

It is possible to carry out a validation of each measurement read to detect the incoherencies therein. A first test consists in verifying that each measurement lies within coherent limits with the physical quantity measured by the sensor. It is thereby possible to dismiss measurements of which the values are clearly erroneous on account of out-of-order sensors, such as for example a negative temperature in degrees Celsius for the water of the secondary circuit. According to another test, the standard deviation of each temporal series of measurements of the same sensor must be comprised within limits corresponding to a normal standard deviation of the sensor. It is thereby possible to dismiss measurements of which the too high evolution indicates a malfunction of the sensor.

It is then possible to create a Boolean vector as a mirror of the vector of the measured measurements Vₘₑₐₛᵤᵣₑₘₑₙₜₛ^{measured} (of same dimension), which stores the information relative to the success of the tests: a value (e.g. 1) if the tests are successful, and another value (e.g. 0) if the tests have failed. An observation vector of the measurements is then obtained which indicates for each measurement if it is correct and has to be taken into account or on the contrary if it is false and has to be masked, that is to say not taken into account. A false measurement is thereby conserved in the vector but not taken into account in the method (symptoms not observed).

Vector of Expected Values

The healthy model is used with the boundary physical quantities corresponding to those of the system when the measurements have been read. By simulation of the healthy model, the expected measurements are calculated for each internal physical quantity measured by a sensor, which makes it possible to know the expected value of each measurement of the vector of the measurements. The simulation makes it possible to determine the reference corresponding to the healthy operation of the system (i.e. in the absence of a fault) in the boundary conditions to which it is subjected. Hence, each simulation is unique. A vector is thereby obtained (step S02) of the expected measurements V_{expected}^{simulated}, of same dimension as the vector of the measured measurements, which groups together the values of the internal physical quantities determined by simulation for the healthy model.

Vector of Actual Symptoms

The vector of actual symptoms is next determined (step S03). The vector of actual symptoms V_{symptoms}^{actual} is defined as the difference between the vector of measured measurements Vₘₑₐₛᵤᵣₑₘₑₙₜₛ^{measured} and the vector of expected measurements Vₘₑₐₛᵤᵣₑₘₑₙₜₛ^{simulated}:

V_{symptoms}^{actual}=Vₘₑₐₛᵤᵣₑₘₑₙₜₛ^{measured}−Vₘₑₐₛᵤᵣₑₘₑₙₜₛ^{simulated}

From the vector of actual symptoms and the observation vector of measurements determined previously, the vector of observed actual symptoms is defined, which is defined as the reduction of the vector of actual symptoms to only the validated measurements V_{symptoms}^{actual,observed}.

Complete Fault Vector

The complete fault vector is defined as the vector making an inventory of the values of each fault in the system. It is of the dimension of the number of faults taken into account in the method. As an indication, for a secondary circuit, it is possible to envisage several tens of faults, on account of the complexity of the circuit and its numerous components. By convention, if one has no idea of the value of a fault (the most frequent case) a zero value is filled in by default in the complete vector of faults.

However, if a set of faults affecting the system at the moment of implementation of the method is known beforehand, it is possible for an operator to fill in their values. In this case, a vector of known faults V_{faults}^{known} is created from the complete vector of faults. In the remainder of the method, the vector of known faults V_{faults}^{known} thereby completes the search for the searched for faults, which is then restricted to values representative of the faults listed in the list of possible faults not included in the set defined by the vector of known faults V_{faults}^{known}.

The vector of known faults makes it possible to draw on the potential knowledge of a fault by the operator, and thus makes it possible to improve the characterisation of other faults since this known fault will be taken into account as such in the method.

A Priori Fault Laws

The a priori probability density of each fault is defined as a semi-continuous law derived from the combination:
of a Boolean law representative of the probability of presence of the fault,
of a constant law (non-informative) scanning the different values of physically acceptable faults.

General Principle

The general principle of the method is based on the following approximation:

V_{symptoms}^{real}≅M_{faults}×V_{faults}

with V_{symptoms}^{actual} the vector of actual symptoms, M_{faults} the fault matrix and V_{faults} the vector of faults. The fault matrix is here a prerequisite which serves as approximation for the model of the system embedding all of the faults of the method. It may be remarked that the fault matrix may be easily used in an iterative manner and may consequently be substituted, in the iterative process described hereafter, by the simulation of a modelling of the system under degraded conditions which would take several seconds at each iteration. Consequently, the use of the fault matrix makes it possible to considerably limit the computation time.

The symptoms are linked to the faults by a causal stochastic relationship, that is to say that the faults cause the symptoms. The physical causality (deterministic) is determined by the fault matrix. For a given combination of faults, the fault matrix makes it possible to calculate the vector of symptoms associated with the combination of faults.

From the deterministic physical causality, characterised by the fault matrix, is deduced the stochastic causality which is understood as the combination of the deterministic causality imposed by physics, to which is added a stochastic noise due to the sources of uncertainties linked to the measurement and to the representativeness of the healthy model and the fault matrix.

The filling in of a priori laws of unknown faults, values of known faults, probabilistic causal relationships linking each fault and accumulation of faults with their symptoms (via the fault matrix) as well as the observation of an important number of symptoms meets the conditions necessary and sufficient for the elaboration of a Bayesian tree of which it will be necessary to determine the joint law.

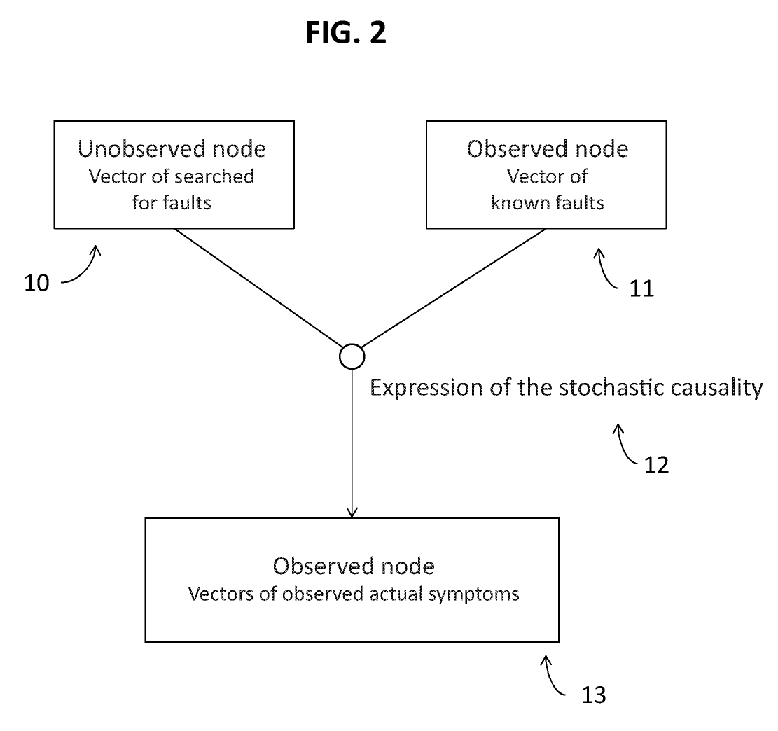

FIG. 2 shows an example of a such a Bayesian tree. An unobserved node 10 corresponds to the searched for vector of faults, whereas an original observed node 11 corresponds to the vector of known faults. The expression of the stochastic causality 12 corresponds to the use of the fault matrix and to the introduction of the stochastic noise linked to the representativeness of the healthy model, the fault matrix and the measurement uncertainties. The resulting observed node 13 corresponds to the vector of observed actual symptoms.

Joint Law

It is possible to carry out in an algorithmic manner the construction of the joint law of the Bayesian tree thereby defined. The random variables are the searched for faults (i.e. which are not covered by the vector of known faults). The observations are the observed actual symptoms and the vector of known faults.

Let X1, X2, Xn be the “n” random variables that it is wished to characterise and O1, O2, . . . , Ok the “k” observations made on the system. The joint law of the problem is then of dimension n:

f_{X1,X2, . . . ,Xn|O1,O2, . . . ,Ok}(x₁,x₂, . . . ,xₙ)

Knowledge of the joint law makes it possible to characterise fully the diagnosis of the system.

It is however difficult to construct the joint law of the problem analytically. However, it is possible to characterise in a heuristic manner the searched for joint law, using an algorithm operating by successive samplings of values for all the random variables of the problem, and of which each new sampling depends exclusively on the preceding sampling and the parameterisation of the Bayesian network.

The method is described hereafter in greater detail in the case of the Metropolis algorithm, which is an example of a Monte Carlo Markov Chains algorithm, which makes it possible to reproduce samples that converge in large dimensions to samples sampled pseudo randomly according to this joint law. Consequently, with a sufficiently large number of samplings, the sample produced by the Monte Carlo Markov Chains algorithm is representative of the searched for joint law. It is however to be noted that the Metropolis algorithm is not the only algorithm that makes it possible to reproduce by successive samplings a sample derived from the joint law.

Iterations

To empirically reconstruct the joint law, one proceeds in an iterative manner for a given number of iterations, which may be large, typically greater than 10,000 iterations, and for example 100,000 iterations. Each iteration starts from a current vector of faults V_{faults}^{current}, resulting from the preceding iteration, which groups together values representative of one or more faults. The current vector of faults corresponds to an expression of the vector of random variables of the joint law.

It is to be noted that if faults affect the system in a certain manner at the moment when the method is being carried out, the operator is able to fill in the vector of known faults V_{faults}^{known}. In this case, the current vector of faults is completed by the vector of known faults by concatenation of the components of the two vectors to create the completed current vector of faults V_{faults}^{current,completed}.

To initialise the process (first iteration), for the current vector of faults V_{faults}^{current} is taken a first vector of faults assumed to be the first sampling of the joint law. This first vector of faults may be initialised at 0 (no degradation) for unknown faults.

During iterations, a current vector of symptoms V_{symptoms}^{current} determined from the completed current vector of faults V_{faults}^{current completed} (derived from the concatenation of the current vector of faults and the vector of known faults) using the fault matrix M_{faults}. This determination simply consists in applying the fault matrix M_{faults} to the completed current vector of faults:

V_{symptoms}^{current}=M_{faults}×V_{faults}^{current completed}

The expected behaviour of the system in the presence of faults in the current vector of faults is thus obtained, potentially completed by known faults. It is to be noted that this current vector of symptoms may be known from the preceding iteration where it has been calculated. It is then not necessary to re-calculate it.

It is now appropriate to define a current vector of observed symptoms V_{symptoms}^{current,observed} from the observation vector of measurements defined above and the current vector of symptoms V_{symptoms}^{current}. The current vector of observed systems V_{symptoms}^{current,observed} is a reduction of the current vector of symptoms V_{symptoms}^{current} to only the validated measurements. In the same way as the current vector of symptoms, this current vector of observed symptoms may be known from the preceding iteration where it has been calculated. It is then not necessary to re-calculate it.

A proposed vector of faults is determined (step S04) from the current vector of faults by a pseudo-random sampling using a probability law on each of the values of the faults of the current vector of faults. The probability law, preferably symmetrical, is used as transition function, or “jumping function”. The jumping function is parameterised in a coherent manner with the degradations (random variables of the joint law) in such a way as to enable the pseudo-random sampling of the proposed vectors of faults step by step. As an example, the jumping function may take the form of a Gaussian distribution of which the covariance matrix is adapted to the amplitudes of the ranges of acceptable values for each searched for fault.

By pseudo-random sampling in the transition function is thereby proposed a proposed vector of faults V_{faults}^{proposed} to be included in the sample which will be with time representative of the joint law.

A proposed vector of symptoms V_{symptoms}^{proposed} is then determined from the completed proposed vector of faults V_{faults}^{proposed completed} (derived from the concatenation of the proposed vector of faults V_{faults}^{proposed} and the vector of known faults V_{faults}^{known}) using the fault matrix M_{faults}. This determination simply consists in applying the fault matrix M_{faults} to the completed proposed vector of faults:

V_{symptoms}^{proposed}=M_{faults}×V_{faults}^{proposed completed}

The expected behaviour of the system in the presence of faults in the completed proposed vector of faults is thus obtained. It is now appropriate to define the proposed vector of observed symptoms V_{symptoms}^{proposed,observed} from the observation vector of symptoms defined above and the proposed vector of symptoms V_{symptoms}^{proposed}. The proposed vector of observed symptoms V_{symptoms}^{proposed,observed} is a reduction of the proposed vector of symptoms V_{symptoms}^{proposed} to only the validated measurements.

The probability of acceptance of the proposed vector of faults is next determined (step S05) by comparing the density of the joint law at the point of the proposed vector of faults with the density of the joint law at the point of the current vector of faults. One uses the vector of observed actual symptoms, the fault matrix, the proposed vector of faults, the current vector of faults, the probabilistic distribution of the vector of actual symptoms given the completed current vector of faults, the probabilistic distribution of the vector of symptoms given the completed proposed vector of faults (defined via the fault matrix and the probabilistic characterisation of the causality linking each symptom to the faults), and the a priori probability distribution of occurrences of the values of the proposed vector of faults to determine this probability of acceptance.

From the current (respectively proposed) vector of symptoms and the metrological uncertainties, uncertainties of representativeness of the models and uncertainties of representativeness of the fault matrix, the probability distribution of the vector of actual symptoms is defined given the completed current vector of faults (respectively given the completed proposed vector of faults).

The current (respectively proposed) vector of symptoms is the expectation of the probabilistic distribution of the vector of actual symptoms given the current vector of faults (respectively of the vector of actual symptoms given the proposed vector of faults).

The current vector of faults is then replaced or not by the proposed vector of faults as a function of this comparison, and more specifically with a probability equal to the probability of acceptance (step S06).

Mathematical Formalisation of the Calculation of the Probability of Acceptance of the Proposed Vector of Faults

To simplify the reading of the mathematical formalisation that follows, it will be considered that no fault is known a priori. Consequently, and in this particular case, the current vector of faults V_{faults}^{current} is strictly equal to the completed current vector of faults V_{faults}^{current,completed}.

The joint law of the problem posed here is defined as the probability law of the random variable of the searched for faults D, given the observations of the problem, here limited to only actual symptoms (since by hypothesis, no fault is known). S will note the random variable of the symptoms, observed at the values defined by the vector of observed actual symptoms V_{symptoms}^{actual,observed}.

∀d,f(D=d|S=V_{symptoms}^{actual,observed})

The ratio is calculated of the joint law evaluated at the proposed vector of faults V_{faults}^{proposed} over the joint law evaluated at the current vector of faults V_{faults}^{current} and, by definition, given the vector of observed actual symptoms V_{symptoms}^{actual,observed}:

$$R = \frac{f ( D = {V}_{faults}^{proposed} \vert S = {V}_{symptoms}^{actual , observed} )}{f ( D = {V}_{faults}^{current} \vert S = {V}_{symptoms}^{actual , observed} )}$$

It may be remarked that via the Bayes theorem:

$$f ( D = {V}_{faults}^{proposed} \vert S = {V}_{symptoms}^{actual , observed} ) = \frac{f ( S = {V}_{symptoms}^{actual , observed} \vert D = {V}_{faults}^{proposed} ) \times f ( D = {V}_{faults}^{proposed} )}{f ( S = {V}_{symptoms}^{actual , observed} )}$$

Which gives:

$$R = \frac{f ( D = {V}_{faults}^{proposed} \vert S = {V}_{symptoms}^{actual , observed} )}{f ( D = {V}_{faults}^{current} \vert S = {V}_{symptoms}^{actual , observed} )}$$

$$R = \frac{f ( S = {V}_{symptoms}^{actual , observed} \vert D = {V}_{faults}^{proposed} ) \times f ( D = {V}_{faults}^{proposed} )}{f ( S = {V}_{symptoms}^{actual , observed} \vert D = {V}_{faults}^{current} ) \times f ( D = {V}_{faults}^{current} )}$$

In this expression may be recognised:

f(S=V_{symptoms}^{actual,observed}|D=V_{faults}^{proposed}): the probabilistic distribution of the vector of observed symptoms given the proposed vector of faults, evaluated at the vector of observed actual symptoms. This probabilistic distribution is defined from the proposed vector of faults, the fault matrix and the probabilistic characterisation of the causality linking each symptom to the faults.
f(S=V_{symptoms}^{actual,observed}|D=V_{faults}^{current}): the probabilistic distribution of the vector of observed actual symptoms given the current vector of faults, evaluated at the vector of observed actual symptoms. This probabilistic distribution is defined from the current vector of faults, the fault matrix and the probabilistic characterisation of the causality linking each symptom to the faults.
f(D=V_{faults}^{proposed}): the value at the point corresponding to the proposed vector of faults of the a priori probability distribution of the fault vector;
f(D=V_{faults}^{current}): the value at the point corresponding to the current vector of faults of the a priori probability distribution of the fault vector.

$$P ( acceptance ) = \{ \begin{matrix}1 if R \geq 1 \\ R if R < 1\end{matrix}$$

Thus, the proposed vector of faults V_{faults}^{proposed} replaces the current vector of faults V_{faults}^{current} if R is greater than or equal to 1, and the proposed vector of faults V_{faults}^{proposed} has a probability R of replacing the current vector of faults V_{faults}^{current} if R is less than 1.

If it is accepted, the proposed vector of faults is retained in the sample of results and will replace the current vector of faults with a view to the sampling of the next proposed vector of faults. If it is refused, the proposed vector of faults is not retained, and it is the current vector of faults that is counted a second time in the sample of results and which is again used as current vector of faults in the following iteration.

The algorithm proceeds in a heuristic manner, it stops on demand without objective of convergence, generally after a determined number of iterations. At each iteration, a new vector of faults is added to the sample.

Results

Following the iterations, a final sample is available constituted of the vectors of faults which have in turn been proposed vectors of faults and current vectors of faults. The final sample is considered as a discrete approximation of the searched for joint law. It is then easy to interrogate it to establish the characterisation of the fault.

The first current vector of faults may potentially lie in a zone of very low density of the joint law. In this case, a certain delay in convergence towards zones having a higher density will be observed. In the case of a very large sample of results, this initial trajectory has a negligible weight which does not perturb the reconstruction of the joint law. In practice, this initial trajectory leads to an over-representation of certain values in the reconstituted joint law. Consequently, it is possible to choose not to retain in the final sample the vectors of faults before having reached a certain number of iterations, for example at least 1000 or 10,000 iterations.

It is also possible, to limit the autocorrelation linked to successive step by step samplings derived from the transition function (and to come closer to a sample sampled pseudo randomly in the joint law), to only retain in the final sample a proportion of the vectors of faults derived from the iterations, for example less than one sampling out of three, out of five, or even out of ten.

Exploitation of the Results

To carry out the characterisation of the faults affecting the system, a focus is made on the enumeration of the samplings of each of the faults in the final sample. A fault is thereby characterised (step S07) by counting the number of iterations having involved said fault.

It is possible to determine the probability of each fault, that is to say the probability P(faultᵢ|actual symptoms) that this fault i is actually present in the considered system given the observed actual symptoms:

$$P ( {fault}_{i} \vert {V}_{symptoms}^{actual observed} ) = \frac{NB {samplings}_{fault i}}{NB {samplilngs}_{total}}$$

with NB samplings_{fault i} the number of samplings in the final sample showing the fault i (that is to say the number of retained occurrences of the vector of faults having a non-zero value of this fault i during the iterations), and NB samplingsₜₒₜₐₗ the total number of samplings in the final sample (that is to say the number of retained samples).

Similarly, it is also possible to determine the probability of a combination of faults, that is to say the probability that several faults i, j and k are simultaneously present in the considered system given the observed actual symptoms:

$$P ( {fault}_{i , j , k} \vert {V}_{symptoms}^{actual observed} ) = \frac{NB {samplings}_{fault i , j , k}}{NB {samplings}_{total}}$$

with NB samplings_{fault i,j,k} the number of samplings in the final sample showing the fault i, the fault j and the fault k (that is to say the number of retained occurrences of the vector of faults having non-zero values associated with these faults i, j, k). By definition, the probability of a combination of faults corresponds to the probability of the intersection of these faults. By extension, it is possible to identify the probability of any logic proposition concerning the presence of one or more faults.

It is also possible to quantify a fault, by determining the value that is associated with it as corresponding to the average of the values di taken by the vectors of faults that make this fault i appear in the final sample, that is to say the values of di that are strictly different to 0:

Value_{fault i}=average(di≠0)

Validation

Once the most probable diagnosis has been identified, it is wished to ensure retrospectively that among the faults embedded in the library indeed figure those explaining the observed symptoms. Indeed, by construction, the diagnosis thereby performed is incomplete since it does not embed the totality of the faults that could occur on the system. Thus, if a non-anticipated fault expresses itself, the diagnosis would be false, or at least incomplete, since a part only of the problems may be then diagnosed.

To overcome this problem, the method may include a validation step in which a criterion for accepting the diagnosis is calculated, to guard against unsatisfactory diagnoses and to identify the occurrence of a non-anticipated problem.

A state of the system (that is to say the characterisation of a fault or a combination of faults present in the system) is considered acceptable if the vector of symptoms that is associated with it (calculated via the fault matrix) is coherent with the vector of observed actual symptoms.

To make this judgement, a vector of theoretical symptoms V_{symptoms}^{theoretical} is reconstructed which corresponds to the expression of the faults diagnosed completed by the vector of known faults and grouped together in a vector V_{faults}^{diagnosed completed} through the fault matrix M_{faults}:

V_{symptoms}^{theoretical}=M_{faults}×V_{faults}^{diagnosed completed}

This vector of theoretical symptoms is then compared to the vector of observed actual symptoms to decide a posteriori on the acceptability of the diagnosis. The alert criterion will thus be dependent on the distance separating the vector of theoretical symptoms thereby reconstructed from the vector of actual symptoms. It is possible for this comparison to use any distance criterion, such as the most common norms (absolute value of the differences, Euclidian norm, etc.).

It is possible to associate with the vector of symptoms a probabilistic distribution representative of the capacity of those skilled in the art to interpret each value thereof, which comes down to associating with each vector of symptoms an uncertainty. This uncertainty may be entered in the form of a multinomial law, centred on the vector of symptoms.

The sources of uncertainties borne by the vector of symptoms directly echoes those used for the characterisation of the probabilistic causality linking the symptoms to the faults in the Bayesian process described above. They are mainly of several types that it is preferable to limit:
error specific to the measurement, designated metrological error;
error of representativeness of the healthy model (obtained in the setting phase of the digital model);
error of representativeness of the fault matrix.

The errors thereby quantified make it possible to parameterise a covariance matrix of the probability law (e.g. multinormal) used to characterise the variability of the vector of symptoms. It is thus possible to characterise the confidence intervals of the probability law to quantity the validation criterion of the diagnosis. It is notably possible to consider that the diagnosis validation criterion corresponds to the minimum value, noted alpha, such that the vector of observed actual symptoms is within the alpha level confidence interval of the multinormal law (in the elliptical definition of the confidence interval) centred on the vector of theoretical symptoms.

Faced with an invalid diagnosis, it is possible to rely on the vector of observed actual symptoms to carry out a complementary study and potentially to identify a fault of the diagnosis unknown until then. To enrich future diagnosis for the search for this new fault, it then suffices to modify the fault matrix as evoked above in order to make it take this fault into account once said fault has been identified by other means (for example through professional expertise).

The invention is not limited to the embodiment described. Modifications remain possible, notably from the viewpoint of the constitution of the various elements or by substitution of technical equivalents, without all the same going beyond the field of protection of the invention.

1. Method for characterising one or more faults in a system grouping together a plurality of internal physical quantities and delimited by a plurality of boundary physical quantities,
the system being modelled by a healthy model establishing relationships linking said internal physical quantities with one another and with the boundary physical quantities in the absence of a fault, a fault being defined as an alteration in the relationships linking said internal physical quantities with one another and with the boundary physical quantities with respect to the healthy model,
said system being provided with a plurality of sensors measuring values of internal physical quantities and external physical quantities,
the method comprising:
determining a vector of the measured measurements of a set of internal physical quantities by reading the values of internal physical quantities measured by the sensors,
determining a vector of actual symptoms by the difference between the vector of measured measurements and a vector of expected measurements, said vector of expected measurements grouping together values of internal physical quantities obtained by simulation of the healthy model from the boundary physical quantities,
wherein the method further includes the implementation of the steps of:
for a determined number of iterations:
determination of a proposed vector of faults from the current vector of faults by a pseudo-random sampling using a probability law on each of the fault values of the current vector of faults, a vector of faults grouping together values representative of one or more faults;
determination of a probability of acceptance of the proposed vector of faults using the vector of actual symptoms, a fault matrix, the current vector of faults, a probabilistic distribution of the vector of actual symptoms given the current vector of faults, the proposed vector of faults, a probabilistic distribution of the vector of actual symptoms given the proposed vector of faults, and an a priori probability distribution of occurrences of a values of the fault vector, said fault matrix grouping together consequences of each fault on the internal physical quantities;
replacement or not of the current vector of faults by the proposed vector of faults as a function of the probability of acceptance of the proposed vector of faults,
characterising a fault by counting a number of iterations having involved said fault in a current vector of faults.

2. The method of claim 1, wherein the determination of the probability of acceptance of the proposed vector of faults uses in addition a proposed vector of symptoms and a current vector of symptoms, the current vector of symptoms being determined from the current vector of faults using the fault matrix, and the proposed vector of symptoms being determined from the proposed vector of faults using the fault matrix.

3. The method of claim 1, wherein each column of the fault matrix corresponds to a signature vector of at least one fault representative of an impact of said fault on the internal physical quantities measured by sensors, and a number of lines of the matrix is determined by the number of measured internal physical quantities taken into account and a number of columns of the matrix is determined by a number of faults taken into account.

4. The method of claim 3, comprising a prior step of determination of the fault matrix, in which is determined for each fault:
a first vector of simulated measurements by simulation of the healthy model from the boundary physical quantities;
a second vector of simulated measurements by simulation of the healthy model by altering the relationships linking said internal physical quantities with one another and with the boundary physical quantities of the healthy model as a function of the fault with the same boundary physical quantities;
the signature vector of the fault corresponding to a difference between the second vector and the first vector.

5. The method of claim 1, wherein a set of faults affecting the system are known beforehand and entered into a vector of known faults, and during the iterations, the current vector of faults is completed by the vector of known faults.

6. The method of claim 5, wherein the current vector of symptoms is determined from the fault matrix, the current vector of faults and the vector of known faults, and the proposed vector of symptoms is determined from the fault matrix, the proposed vector of faults and the vector of known faults.

7. The method of claim 1, wherein the characterisation of a fault includes determining a probability of the presence of the fault in the system and/or the determination of a value of this fault.

8. The method of claim 1, wherein the probability of acceptance of the proposed vector of faults is determined by comparing a density of the joint law at a point of the proposed vector of faults with a density of the joint law at a point of the current vector of faults, the densities of the joint law at the aforementioned points being determined by the vector of actual observed symptoms, the fault matrix, the proposed vector of faults, the current vector of faults, the probabilistic distribution of the vector of actual symptoms given the current vector of faults, the probabilistic distribution of the vector of actual symptoms given the proposed vector of faults, and the a priori probability distribution of occurrences of the values of the proposed vector of faults.

9. Non-transitory computer readable medium comprising programme code instructions stored thereon for executing the steps of the method according to claim 1, when said on-transitory computer readable medium is read by a computer.
